(19) United States
(12) Patent Application Publication
(10) Pub. No.: US 2007/0266838 A1
(43) Pub. Date: Nov. 22, 2007

(54) Saw blade mounting structure of a scroll saw

(75) Inventor: Jung-Huo Chen, Taichung (TW)

Correspondence Address: BACON & THOMAS, PLLC, 625 SLATERS LANE, FOURTH FLOOR, ALEXANDRIA, VA, 22314, US

(73) Assignee: Rexon Industrial Corp., Ltd., Taichung (TW)

(21) Appl. No.: 11/798,522

(22) Filed: May 15, 2007

(30) Foreign Application Priority Data
May 17, 2006 (TW) 095208424

(51) Int. Cl. B27B 19/10

(52) U.S. Cl. 83/699.21; 83/783

(57) ABSTRACT

A saw blade mounting structure formed of two saw blade clamps and used in a scroll saw to hold a saw blade between two suspension arms in which each saw blade clamp comprises a mounting block pivotally connected to one suspension arm and provided with a through hole and a stop flange, a clamping block with a through hole, an operating member, a first rod member fixedly connected to the operating member and inserted through the through hole of the clamping block, a second rod member eccentrically extending from one end of the first rod member and inserted through the through hole of the mounting block and screwed into a check nut for enabling the first rod member to move the clamping block relative to the stop flange of the mounting block so as to lock/release the saw blade upon forward/backward rotation of the operating member.

### BACKGROUND OF THE INVENTION

1. Field of the Invention

The present invention relates to a scroll saw and more specifically, to a saw blade mounting structure for a scroll saw.

2. Description of the Related Art

A scroll saw is a fine-toothed saw with a narrow blade, used to cut curved outlines. A scroll saw generally comprises an upper arm, a lower arm, and a saw blade fastener provided at one end of each of the upper arm and the lower arm to hold a saw blade across a worktable on which the workpiece is placed and moved toward the saw blade for cutting by the saw blade.

FIGS. 4 and 5 show a saw blade mounting structure for a scroll saw according to the prior art. According to this design, the saw blade mounting structure comprises two saw blade fasteners respectively provided at the distal end of each of an upper arm 60 and a lower arm 61 to hold a saw blade 65. Each saw blade fastener comprises a U-bar 62, which is fixedly fastened to the distal end of the arm 60 or 61 and has a curved mounting end provided with a notch 621. A saw blade connector 63, which has a transverse hanging rod 631 horizontally disposed at one end is hung on the curved mounting end of the U-bar 62 over the notch 621, and includes a vertically extending mounting hole 632 vertically disposed at the other end for receiving one end of the saw blade 65, and two screw holes 633 horizontally aligned in a line in communication with the vertically extending mounting hole 632, and two lock screws 64 respectively threaded into the screw holes 633 and stopped against one end of the saw blade 65 to lock the saw blade 65 to the saw blade connector 63. According to this design, the two lock screws 64 are respectively stopped against the corresponding end of the saw blade 65, thereby holding down the saw blade 65. The limited contact area between each lock screw 64 and the saw blade 65 is insufficient to hold down the saw blade 65 against a high stretching force. Further, the transverse hanging rod 631 of the saw blade connector 63 must be hung on the curved mounting end of the U-bar 62 over the notch 621 during installation. This mounting procedure is complicated.

FIG. 6 shows two different types of saw blades 70 for a scroll saw, one type 71 with a pin 711 at each end, and the other type 72 without pin. The type 71 with a pin 711 at each end is not insertable into the vertically extending mounting hole 632 of the aforesaid saw blade connector 63.

### SUMMARY OF THE INVENTION

The present invention has been developed in view of the aforementioned circumstances. The saw blade mounting structure comprises two clamps respectively installed in one end of each of two parallel arms to secure a saw blade between said two parallel arms for movement with said parallel arms relative to a worktable to cut a workpiece being placed on said worktable and moved toward said saw blade. The clamps each comprise a mounting block, a clamping block, and a lock. The mounting block is connected to a distal end of one of the two parallel arms, and comprises a base, a through hole cut through the base, and a stop flange extending from one side of the base. The clamping block has a through hole, and a clamping face for stopping one end of the saw blade against the stop flange of the mounting block to secure the saw blade to the mounting block. The lock is for locking the clamping block to the mounting block, and comprises an operating member, a first rod member, and a second rod member. The first rod member has a first end fixedly connected to the operating member, and a second end inserted through the through hole of the clamping block. The second rod member has a first end eccentrically connected to the second end of the first rod member, and a second end inserted through the through hole of the mounting block.

Because the second rod member is eccentrically connected to one end of the first rod member remote from the operating member, the first rod member is turned aside from the central axis of the second rod member to move the clamping block toward the stop flange of the mounting block to clamp the saw blade when the operating member is rotated. When replacing the saw blade, the operating member is rotated in the opposite direction to move the clamping block apart from the stop flange, thereby releasing the saw blade. The use of the clamps allows for easy replacement of the saw blade without tools. Further, the large clamping area between the stop flange and the clamping face ensures a tight connection of the saw blade to the mounting block.

Further, the clamps are suitable for fastening a saw blade with a pin at each end as well as a saw blade without pin. When a saw blade with a pin at each end is used, the pin is stopped at the top edge of the stop flange and the top edge of the clamping block.

### BRIEF DESCRIPTION OF THE DRAWINGS

FIG. 1 is an elevational view of a scroll saw constructed according to the present invention.

FIG. 2 is an exploded view in an enlarged scale of a part of FIG. 1, showing the structure of the saw blade clamp according to the present invention.

FIG. 3 is a schematic drawing showing the installation of the saw blade clamp according to the present invention.

FIG. 4 is an exploded view of a saw blade mounting structure for scroll saw according to the prior art.

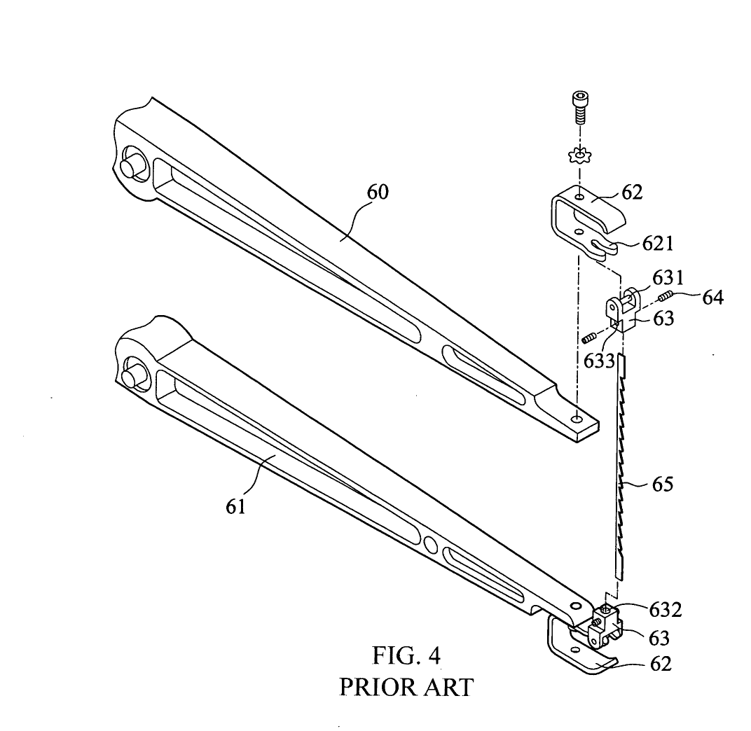

FIG. 5 is a schematic assembly view of the saw blade mounting structure for scroll saw according to the prior art.

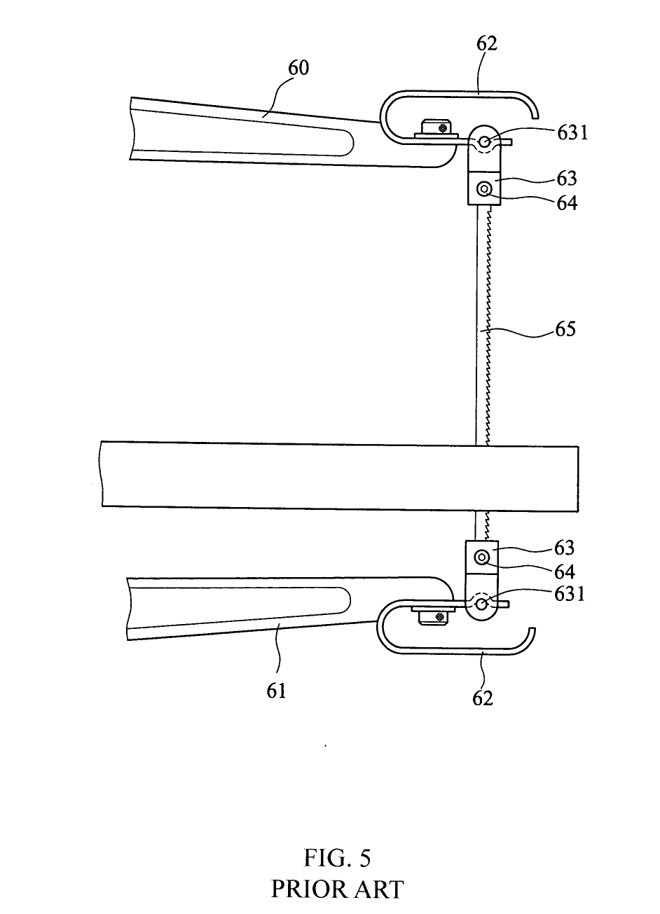

FIG. 6 shows two different types of commercial saw blades for use with a scroll saw.

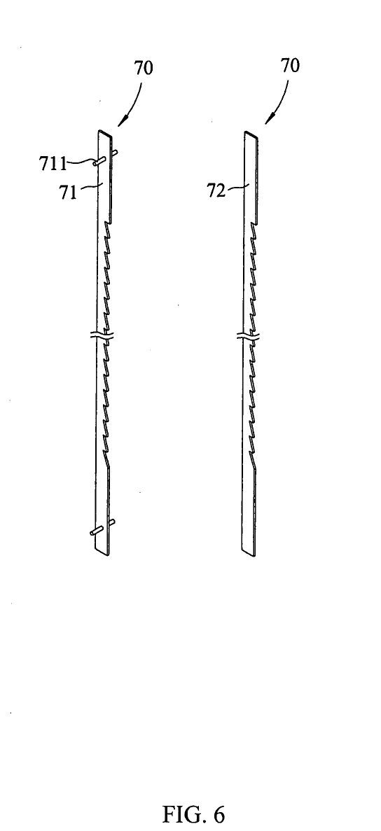

### DETAILED DESCRIPTION OF THE INVENTION

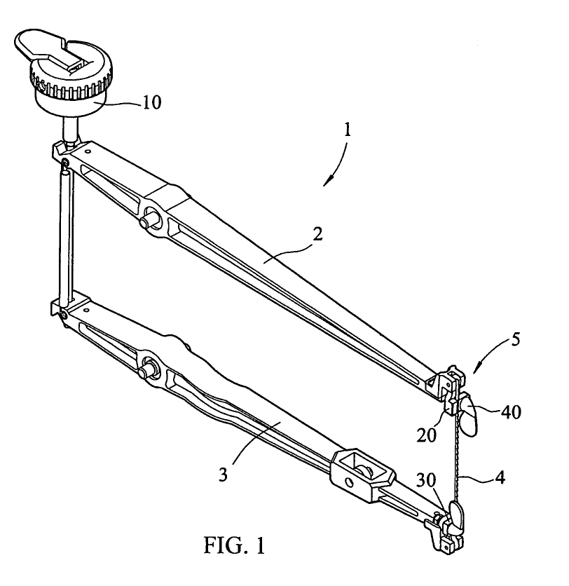

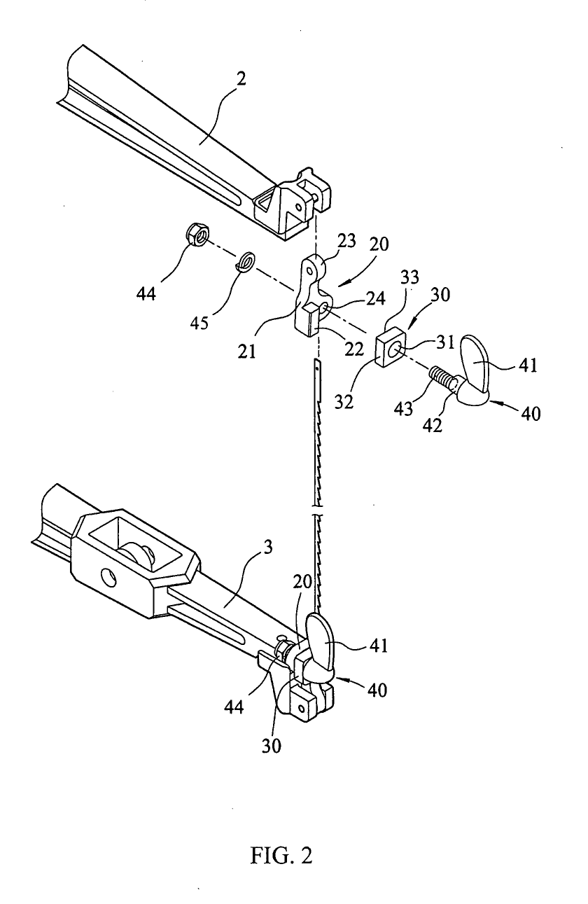

Referring to FIGS. 1 and 2, a scroll saw 1 is shown comprising an upper arm 2 and a lower arm 3 arranged horizontally in a parallel manner, an adjustment device 10 adapted to adjust the gap between the upper arm 2 and the lower arm 3, a saw blade 4, and two clamps 5 respectively fastened to one end of the upper arm 2 and the corresponding end of the lower arm 3 to hold the saw blade 4 vertically between the upper arm 2 and the lower arm 3. The scroll saw 1 further comprises a worktable (not shown). The saw blade 4 is inserted through an opening (not shown) on the worktable and is moved vertically with the upper arm 2 and the lower arm 3 to cut a workpiece that is placed on the worktable and moved toward the saw blade 4.

The aforesaid clamps 5 each are comprised of a mounting block 20, a clamping block 30, and a lock 40.

The mounting block 20 comprises a base 21, a stop flange 22 perpendicularly extending from one side of the base 21, a lug 23 disposed at the top side of the base 21 and pivotally connected to one end of the upper arm 2 (or lower arm 3), and a through hole 24 passing through front and back sides of the base 21.

The clamping block 30 is substantially a rectangular block having a through hole 31 passing through the front and back sides thereof corresponding to the through hole 24 of the mounting block 20, a clamping face 32 corresponding to the stop flange 22 of the mounting block 20, and an abutting face 33 facing the base 21 of the mounting block 20 for abutting against the base 21. The clamping face 32 and the abutting face 33 are substantially arranged at right angles.

The lock 40 comprises an operating member 41, a first rod member 42, a second rod member 43, and a nut 44. The operating member 41 has a flat part for providing a holding area for the fingers of a user to grasp and to rotate the operating member 41. The first rod member 42 has one end fixedly connected to the operating member 41 and the other end eccentrically connected with one end of the second rod member 43. The second rod member 43 is a screw rod. The dimension of the through hole 24 of the mounting block 20 fits the dimension of the cross section of the second rod member 43. The dimension of the through hole 31 of the clamping block 30 fits the dimension of the cross section of the first rod member 42. The dimension of the through hole 24 of the mounting block 20 is smaller than the dimension of the through hole 31 of the clamping block 30. Further, the extending direction of the first rod member 42 and the extending direction of the second rod member 43 are perpendicular to the abutting face 33 of the clamping block 30.

During installation, the first rod member 42 is inserted through the through hole 31 of the clamping block 30 and stopped at one side of the base 21 of the mounting block 20 around the through hole 24, the second rod member 43 is inserted through the through hole 24 of the mounting block 20. The nut 44 is a check nut threaded onto the second rod member 43 and stopped at one side of the base 21 of the mounting block 20 opposite to the clamping block 30. Further, a spring washer 45 may be mounted on the second rod member 43 and stopped between the nut 44 and the mounting block 20 to prohibit downward biasing or movement of the operating member 41 due to the effect of gravity.

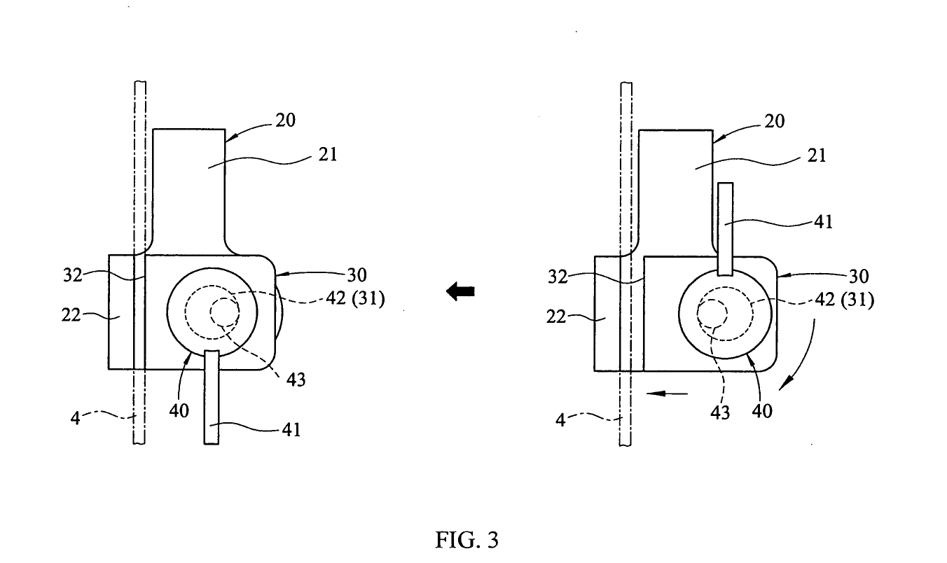

Referring to FIG. 3, when rotating the operating member 41 is rotated, the operating member 41 and the first rod member 42 deflect from the central axis of the second rod member 43, and the first rod member 42 moves the clamping block 30 relative to the mounting block 20, thereby causing the stop flange 22 and the clamping face 32 to hold down the saw blade 4.

As stated above, the second rod member 43 is eccentrically connected to one end of the first rod member 42 remote from the operating member 41. Therefore, when the operating member 41 is rotated, the first rod member 42 is turned aside from the central axis of the second rod member 43 to move the clamping block 30 toward the stop flange 22 of the mounting block 20 to clamp the saw blade 4. When replacing the saw blade 4, the operating member 41 is rotated in the opposite direction to move the clamping block 30 apart from the stop flange 22, thereby releasing the saw blade 4. The use of the clamps 5 allows for easy replacement of the saw blade 4 without tools. Further, the large clamping area between the stop flange 22 and the clamping face 32 ensures tight connection of the saw blade 4 to the arm 2 or 3.

Further, the clamps 5 are suitable for fastening a saw blade with a pin at each end as well as a saw blade without pin. When a saw blade with a pin at each end is used, the pin is stopped at the top edge of the stop flange 22 and the top edge of the clamping block 30.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A saw blade mounting clamp for use in mounting a saw blade in a scroll saw having reciprocating parallel arms with distal ends, the clamp comprising:
a mounting block having a base, a through hole passing through said base, and a stop flange extending from a first side of said base;
a clamping block having a through hole, and a clamping face for clamping one end of a saw blade against said stop flange of said mounting block to secure a saw blade to said mounting block; and
a lock for locking said clamping block to said mounting block and having an operating member, a first rod member, having a first end fixedly connected to said operating member and a second end inserted through the through hole of said clamping block, and a second rod member having a first end eccentrically connected to the second end of said first rod member and a second end inserted through the through hole of said mounting block for enabling said first rod member to move said clamping block relative to said stop flange of said mounting block upon rotation of said operating member.

2. The saw blade mounting clamp as claimed in claim 1, wherein the through hole of said mounting block has a dimension fitting a dimension of a cross section of said second rod member; the through hole of said clamping block has a dimension fitting a dimension of a cross section of said first rod member; and the dimension of the through hole of said mounting block is smaller than the dimension of the through hole of said clamping block.

3. The saw blade mounting clamp as claimed in claim 2, wherein said lock further comprises a nut threaded onto said second rod member and stopped at one side of said mounting block opposite to said clamping block.

4. The saw blade mounting clamp as claimed in claim 3, wherein said nut is a check nut.

5. The saw blade mounting clamp as claimed in claim 1, wherein said operating member has a flat part provided for grasping.

6. The saw blade mounting clamp as claimed in claim 1, wherein said mounting block is pivotally connected to a distal end of a reciprocating arm.

7. The saw blade mounting clamp as claimed in claim 1, wherein said clamping block has an abutting face extending in direction perpendicular to said clamping face and adapted to abut against said base of said mounting block.

8. The saw blade mounting clamp as claimed in claim 7, wherein said first rod member and said second rod member extend in a direction perpendicular to said abutting face of said clamping block.

9. A saw blade mounting clamp for use in mounting a saw blade in ascroll saw having reciprocating parallel arms with distal ends, the clamp comprising:
a mounting block pivotally connected to a distal end of a reciprocating arm and having a base, a through hole passing through said base, and a stop flange extending from one side of said base;
a clamping block, having a through hole, and a clamping face for clamping one end of a saw blade against said stop flange of said mounting block to secure a saw blade to said mounting block; and
a lock for locking said clamping block to said mounting block, and having an operating member, with a flat part provided for the grasping, a first rod member, having a first end fixedly connected to said operating member and a second end inserted through the through hole of said clamping block, and a second rod member having a first end eccentrically connected to the second end of said first rod member and a second end inserted through the through hole of said mounting block for enabling said first rod member to move said clamping block relative to said stop flange of said mounting block upon rotation of said operating member.

10. The saw blade mounting clamp as claimed in claim 9, wherein said clamping block has an abutting face extending in direction perpendicular to said clamping face and adapted to abut against said base of said mounting block.

11. A saw blade mounting clamp for use in mounting a saw blade in a scroll saw, the clamp comprising:
a mounting block having a base, a through hole passing through said base, and a stop flange extending from one side of said base;
a clamping block, having a through hole, a clamping face for clamping one end of a saw blade against said stop flange of said mounting block to secure a saw blade to said mounting block, and an abutting face adapted to abut against said base of said mounting block, said clamping face and said abutting face being arranged at right angles; and
a lock for locking said clamping block to said mounting block, and having an operating member, said operating member having a flat part provided for grasping, a first rod member, having a first end fixedly connected to said a operating member and a second end inserted through the through hole of said clamping block, and a second rod member, having a first end eccentrically connected to the second end of said first rod member and a second end inserted through the through hole of said mounting block for enabling said first rod member to move said clamping block relative to said stop flange of said mounting block upon rotation of said operating member.
